(19) United States
(12) Patent Application Publication
(10) Pub. No.: US 2005/0084601 A1
(43) Pub. Date: Apr. 21, 2005

(54) Pumpkin for cooking use and process for producing the same

(75) Inventors: Keiko Kashihara, Kanagawa (JP); Yoshiyuki Fujishima, Kanagawa (JP); Noriki Nio, Kanagawa (JP); Reina Sano, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Ajinomoto Co. Inc., Tokyo (JP)

(21) Appl. No.: 10/500,137

(22) PCT Filed: Jan. 9, 2003
(86) PCT No.: PCT/JP03/00119

(30) Foreign Application Priority Data
Jan. 11, 2002 (JP) 2002-4660

(51) Int. Cl. A23K 1/00

(52) U.S. Cl. 426/615

(57) ABSTRACT

A method for producing pumpkin that does not lose its shape, which comprises immersing a cut of pumpkin in an aqueous solution that containing divalent cationic salt and pectinesterase, wherein the aqueous solution is at a temperature lower than the optimum temperature for the reaction of pectinesterase (5° C. to 30° C., preferably 7° C. to 25° C., and more preferably 10° C. to 20° C.).

### TECHNICAL FIELD

The present invention relates to a method for treating pumpkin suited for heat cooking so as to prevent the pumpkin, which is conveniently used as an ingredient for cooked foods or the like, from losing its shape while cooking. The present invention also relates to pumpkin, which does not disintegrate during mechanical handling, after being cooked.

More specifically, the present invention relates to a method for preventing the deterioration of appearance and texture due to the softening of pumpkin tissues that takes place when pumpkin for cooking is heated for the purpose of sterilization, cooking, or the like, and relates to the thus produced pumpkin for cooking that does not lose its shape.

### BACKGROUND ART

When vegetables are cooked by heating, they tend to lose their shapes so that their appearances and textures are damaged. Particularly, cut pumpkin is prone to significant loss of shape. Pumpkin pieces often fall apart during boiling to a degree that they completely lose their original shapes, and also often lose the cut shapes during subsequent mechanical handling processes.

Regarding methods for preventing the softening of vegetable tissues that take place by heating vegetables for the purpose of sterilization, cooking, or the like, one of methods that have been reported involves immersing tomato in an aqueous solution of calcium chloride for binding a pectic substance, which is a constituent of plant skeletal formation with a calcium salt, thereby strengthening the cell walls (Food Research, 6, 499, 1941). Furthermore, regarding cauliflower, it has been reported that a pectic substance is demethylated by the activation of inherent pectinesterase, and the resultant free carboxyl group binds with a divalent cation, including coexisting calcium within tissues, so as to harden the plant tissues (Food Technology, 15, 160, 1961).

Moreover, regarding potato, it has also been reported that the tissues thereof are hardened by incubating at a temperature ranging from 60° C. to 70° C. for a maximum of 2 hours without adding any external calcium (J. Agr. Food. Chem. 20, 2, 266, 1972).

Several inventions utilizing the above technologies that strengthen the tissues of vegetables have been proposed as shown below.

A method for preventing the softening of vegetables and fruits, which comprises pre-heating for 10 to 180 minutes using any one of water, diluted acidic water, or sugar solution while keeping the surface temperature at least at 45° C. to 75° C. (JP Patent Publication (Kokai) No. 54-107542 A (1979)); a method for preventing rootcrops or fruits and vegetables from disintegration during boiling, which involves soaking pretreatment of fruits and vegetables in a 0.1 to 0.7 wt % calcium salt aqueous solution (JP Patent Publication (Kokai) No. 57-208968 A (1982)); and a method for preventing the softening of vegetables which comprises immersing vegetables in a calcium aqueous solution at a low temperature and subsequently raising the temperature of the aqueous solution with vegetable between 40° C. and 70° C., maintaining such conditions for a certain time period (JP Patent Publication (Kokai) No. 60-237957 A (1985)) have been proposed.

Furthermore, a method for preventing vegetables from disintegration during boiling, which comprises soaking vegetables to a calcium salt aqueous solution and vacuum treatment prior to boiling (JP Patent Publication (Kokai) No. 3-285651 A (1991)); and a method which involves immersing vegetables in an aqueous solution of calcium salt and/or magnesium salt, or in the same aqueous solution containing sugar and/or sugar alcohol dissolved therein before heat cooking (JP Patent Publication (Kokai) No. 4-190756 A (1992)) have been proposed.

Furthermore, a method for preventing the softening of vegetables which involves, when vegetables are heated or frozen, impregnating the vegetables with any one of saline solution, sugar solution, or sugar alcohol solution prior to the process, and then impregnating the vegetables with a calcium salt aqueous solution and/or magnesium salt aqueous solution (JP Patent Publication (Kokai) No. 10-327794 A (1998)); a method for preventing the softening of fruits or vegetables which comprises immersing fruits or vegetables in a pectinesterase solution, and then incubating them between the room temperature and 60° C. by heating the solution (U.S. Pat. No. 2,534,263 specification); and the like have been proposed.

However, all of these methods have limitations such that the resulting effect of preventing softening is insufficient, or vegetables are made to have an unnatural bitterness due to the use of a calcium salt or a magnesium salt at a high concentration.

Moreover regarding pumpkin, it has also been reported that pumpkin does not become hardened even when it is maintained at 60° C. for 2 hours, regardless of the presence or absence of calcium (Nutrition and Food (Eiyo To Shokuryo), 28, 1, 44, 1975).

### SUMMARY OF THE INVENTION

The objective of the present invention is to provide a method to prevent disintegration of pumpkin shape which is prone to heat damage due to the softening of tissue by heat treatment such as cooking or sterilization, and also to provide the pumpkin with good appearance and texture which is suited for cooking.

As a result of intensive studies to solve the above problems, we have discovered that pumpkin for cooking that does not lose its shape can be produced by cutting pumpkin into pieces of any size and shape under desired conditions using an aqueous solution containing a divalent cationic salt and pectinesterase, and we have thus completed the present invention. The present invention comprises each of the following inventions.
(1) A method for producing pumpkin for cooking, which comprises immersing a cut of pumpkin in an aqueous solution that contains a divalent cationic salt and pectinesterase, wherein the aqueous solution is at a temperature lower than the optimum temperature for the reaction of pectinesterase.
(2) The method for producing pumpkin for cooking of (1), wherein the above immersion treatment is carried out with the aqueous solution at a temperature between 5° C. and 30° C.
(3) The method for producing pumpkin for cooking of (1), wherein the above immersion treatment is carried out with the aqueous solution at a temperature between 7° C. and 25° C.
(4) The method for producing pumpkin for cooking of (1), wherein the above immersion treatment is carried out with the aqueous solution at a temperature between 10° C. and 20° C.
(5) The method for producing pumpkin for cooking of any one of (1) to (4), wherein the concentration of the divalent cationic salt in the above aqueous solution is between 0.1% and 5% by weight.
(6) The method for producing pumpkin for cooking of any one of (1) to (5), wherein the content of the pectinesterase in the above aqueous solution is between 1 and 60 P.E.U. per 100 g of the pumpkin.
(7) Pumpkin for cooking, which is produced by the method of any one of (1) to (6) above.
(8) A pumpkin food, which is prepared by heat-cooking of the pumpkin for cooking of (7) above.

Pumpkin used for the present invention may be of any variety. Pumpkin to be treated is preferably cut into any size and any shape prior to treatment, in consideration of, for example, the efficiency of the immersion treatment and the size or the like of ingredients that are preferred for preparing food such as a cooked food.

In the present invention, the type of divalent cation used in the aqueous solution for the immersion treatment is not specifically limited, as long as it can provide the function of pectinesterase of property of disintegration prevention during boiling on pumpkin for cooking. For example, the following compounds are used:
a calcium salt such as calcium chloride, calcium sulfate, tricalcium phosphate, calcium monohydrogenphosphate, calcium dihydrogenphosphate, calcium glycerophosphate, calcium gluconate, calcium L-glutamate, calcium lactate, calcium pantothenate, calcium chloride, calcium hydroxide, calcium pyrophosphate, calcium citrate, and calcium dihydrogen pyrophosphate; and a magnesium salt such as magnesium carbonate, magnesium oxide, magnesium chloride, and magnesium sulfate.

When convenience for use is considered, as a divalent cationic salt, calcium chloride, calcium lactate, and magnesium chloride are preferably used.

The concentration of a divalent cation in the aqueous solution for the immersion treatment also differs depending on the type and the shape of pumpkin, and conditions for treatment. The concentration is generally between 0.1% and 5% by weight and preferably between 0.2% and 1% by weight. For normal immersion treatment, a divalent cationic salt higher than 5% by weight is excessive in amount relative to pumpkin, as a result the pumpkin is made to have significant bitterness. Moreover, a concentration of less than 0.1% by weight is inefficient, because it takes an excessive amount of time and requires a large volume of an aqueous solution for immersion to obtain the desired effect of preventing pumpkin from losing its shape during boiling.

Pectinesterase (EC3.1.1.11) is an enzyme that hydrolyzes the ester linkage of the methylester residue of pectin (poly α-D galacturonic acid) to give methanol and pectic acid. It is known that the thus generated carboxyl group binds via a divalent cation so as to increase the viscosity of pectin and alter the physical properties of plants. Pectinesterase is present in plants such as white clover, alfalfa, tobacco, tomato, and grapefruit, and microorganisms such as Coniophera cerebella, Aspergillus, Penicillium, Erwinia, and Xanthomonas campestris.

Pectinesterase used in the present invention may be any of those types derived from plants or microorganisms. Examples of pectinesterase include pectinesterase derived from an orange peel produced by Sigma Chemical Co., Rapidase produced by DSM Food Specialities and marketed in Europe and America as an enzyme for producing jam, and NovoShape produced by Novozymes A/S and derived from Aspergillus aculeatus. In addition to purified pectinesterase, an extract from plant tissue or a culture broth of a microorganism containing pectinesterase can be used.

The concentration of pectinesterase in an aqueous solution is adjusted according to the required degree of preventing pumpkin from disintegration during boiling. 100 g of pumpkin is treated at 1 to 60 P.E.U. and preferably at 10 to 40 P.E.U. Here, 1 P.E.U. refers to the titer of an enzyme that causes the release of the equivalent of 1 mmol of acid within 1 minute from pectin.

The temperature at which pumpkin is immersed in an aqueous solution containing a divalent cationic salt and pectinesterase is lower than the optimum temperature for the reaction of pectinesterase, and is preferably between 5° C. and 30° C., more preferably between 7° C. and 25° C., and most preferably between 10° C. and 20° C.

The immersion treatment is generally carried out by adding cut of pumpkin pieces for cooking to an aqueous solution pre-adjusted at a given temperature, and then keeping the pumpkin pieces immersed. The temperature of the aqueous solution may be adjusted after adding the pumpkin pieces to the aqueous solution.

The pH of the aqueous solution is not specifically limited, as long as it is in a range that enables pumpkin immersed in the aqueous solution to be actually eaten as a food, and is preferably between pH 3 and pH 8.

The effect of preventing pumpkin from losing its shape can be obtained simply by adding pumpkin to an aqueous solution containing a mixture of a divalent cationic salt and pectinesterase, and then maintaining the pumpkin for 1 to 24 hours under the above temperature conditions. Vacuum treatment may also be carried out to conduct the entire treatment more effectively in a shorter time. The time for carrying out the vacuum treatment is adjusted according to the required effect of preventing pumpkin from losing its shape, and is preferably about 20 minutes to 2 hours in terms of effectiveness.

By means of the above treatment, pumpkin for cooking that does not lose its shape can be obtained. Incidentally, “pumpkin for cooking that does not lose its shape” used herein means pumpkin for cooking that is difficult to be softened by heating, that is, pumpkin that has harder physical properties than those of pumpkin treated under the same conditions using an aqueous solution lacking either one of or both of a divalent cationic salt and pectin methylesterase.

The pumpkin produced by the present invention does not disintegrate by boil treatment or rough mechanical handling at catering service or restaurant. Furthermore, it can be used as frozen vegetable or salad ingredient delivered in the form of frozen food, and also it can be used as an ingredient for retort stew or curry with no disintegration. As described above, according to the present invention, various types of pumpkin for cooking can be obtained, where such pumpkin can come in various sizes, have various shapes, and can maintain such shapes, and the application methods thereof are also varied.

This specification includes part or all of the contents as disclosed in the specification and/or drawings of Japanese Patent Application No. 2002-004660, which is a priority document of the present application.

### BRIEF DESCRIPTION OF THE DRAWINGS

FIG. 1 is a graph showing the effect of temperature on the hardening of pumpkin by pectinesterase (PME).

FIG. 2 is a graph showing the effect of temperature on the hardening of potato by pectinesterase (PME).

FIG. 3 is a graph showing the effect of temperature on the hardening of carrot by pectinesterase (PME).

### BEST MODE OF CARRYING OUT THE INVENTION

The present invention will be hereafter described in detail by referring to examples, but the invention is not limited by these examples.

### EXAMPLE 1

Pectinesterase (NovoShape) was mixed at 20 P.E.U. per 100 g of vegetables into each 0.28% by weight calcium chloride aqueous solution (two-fold weight relative to vegetables) adjusted to between 10° C. and 40° C. Pumpkin, potato, and carrot were cut into pieces in the shape of a 1.5 cm dice, and then added to the solution. The solutions were subjected to vacuum treatment at 50 mmHg for 20 minutes at 10° C., 20° C., 30° C., and 40° C., respectively. After the vacuum treatment, the vegetables were kept intact at 10° C., 20° C., 30° C., and 40° C., respectively, for 1 hour. The vegetables were taken out, and then boiled in a boiling pan for 15 minutes, thereby preparing samples for measuring physical properties.

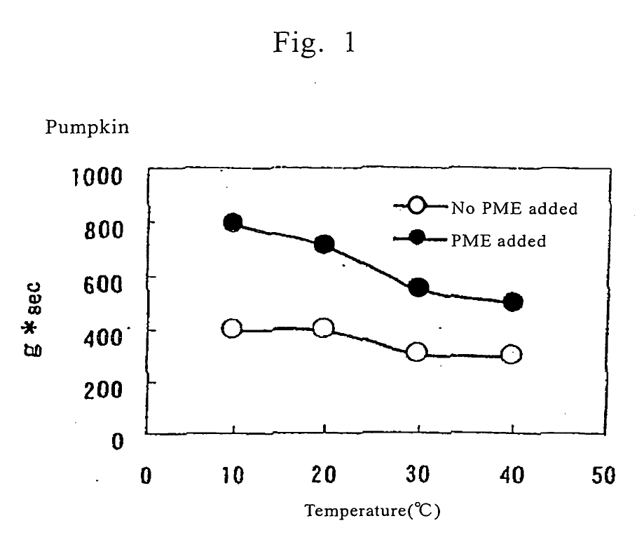

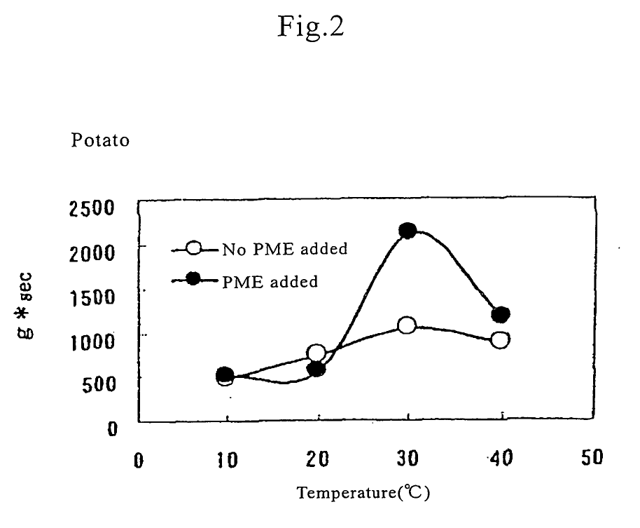

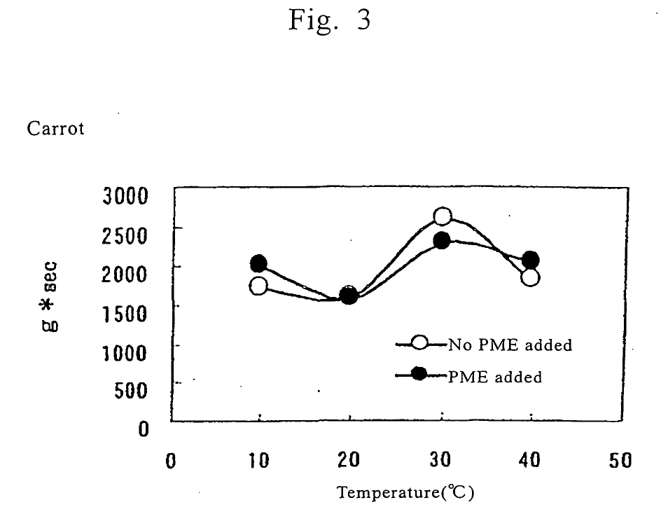

For comparison, vegetables were similarly treated using a 0.28% by weight calcium chloride aqueous solution that does not contain pectinesterase, thereby preparing samples. Physical properties were measured by load measurement by penetration of 5 mm spherical plunger using a texture analyzer (manufactured by Stable Micro Systems Ltd.). The results are shown in FIGS. 1 to 3. In the figures, the horizontal axis indicates temperature, and the vertical axis indicates the total energy loaded onto the spherical plunger to be pushed to a depth of 5 mm into the samples at 1 mm/s.

As is clear from FIG. 1, in the case of the pumpkin, increased physical properties were measured when the pumpkin had been treated with pectinesterase at around 10° C., and it was made to have the hardest physical properties. Compared with the case where no pectinesterase had been added, the effect obtained by this treatment was clear. Moreover, although the degree of hardening due to the treatment with pectinesterase decreased as the temperature for the treatment increased, and the optimum temperature for the reaction of pectinesterase is 45° C. [Biochem. J., 319, 705-712 (1996)], the degree of hardening at 40° C. that is somewhat lower than the degree of hardening at 45° C. was merely approximately a half of that at 10° C.

On the other hand, in the case of the potato and the carrot, they showed harder physical properties when treated at temperatures of 30° C. or more, compared with those when treated at 10° C. However, differences between samples with pectinesterase and samples without pectinesterase could not be clearly confirmed.

In addition, such differences were confirmed with sensory evaluation carried out by 7 panel.

### EXAMPLE 2

Pectinesterase (NovoShape) was mixed at 20 P.E.U. per 100 g of a vegetable into a 0.28% by weight calcium chloride aqueous solution(two-fold weight relative to vegetables) adjusted at 10° C. Pumpkin was cut into pieces in the shape of a 1.5 cm dice, and were added to, immersed, and then maintained in the solution at 10° C. for 24 hours. Subsequently, the pumpkin pieces were removed from the solution, and then boiled in a boiling pan for 15 minutes. The pumpkin pieces that had not been treated with pectin esterase were designated to have values of 0 points. The pumpkin pieces were scored by 9 panel on a −3 (the pumpkin pieces lost their shapes due to boiling) to +3 (the pumpkin pieces did not lose their shapes due to boiling) basis. That is, the panel assigned scores on the basis of whether or not they felt that the pumpkin pieces treated with pectinesterase lost their shapes due to boiling.

As a result, the score of the pumpkin pieces that had been treated with pectinesterase was 2.7, near the highest possible score, and 6 out of 9 panelists assigned the highest score, +3 (the pumpkin pieces did not lose their shapes at all due to boiling).

All publications, patents, and patent applications cited herein are incorporated herein by reference in their entirety.

### INDUSTRIAL APPLICABILITY

According to the present invention, a method for producing pumpkin that does not lose its shape due to heating, that is, pumpkin that does not lose its shape such as through softening or falling apart during boiling that takes place during heating for the purpose of sterilization, cooking, or the like, and has good appearance and texture; and pumpkin that does not lose its shape, which is produced by the method, can be provided.

1. A method for producing pumpkin for cooking, which comprises immersing a cut of pumpkin in an aqueous solution that contains divalent cationic salt and pectinesterase, wherein the aqueous solution is at a temperature lower than the optimum temperature for the reaction of pectinesterase.

2. The method for producing pumpkin for cooking of claim 1, wherein the immersion treatment is carried out with the aqueous solution at a temperature between 5° C. and 30° C.

3. The method for producing pumpkin for cooking of claim 1, wherein the immersion treatment is carried out with the aqueous solution at a temperature between 7° C. and 25° C.

4. The method for producing pumpkin for cooking of claim 1, wherein the immersion treatment is carried out with the aqueous solution at a temperature between 10° C. and 20° C.

5. The method for producing pumpkin for cooking of claim 1, wherein the concentration of the divalent cationic salt in the aqueous solution is between 0.1% and 5% by weight.

6. The method for producing pumpkin for cooking of claim 1, wherein the content of the pectinesterase in the aqueous solution is between 1 and 60 P.E.U. per 100 g of the pumpkin.

7. Pumpkin for cooking, which is produced by the method of claim 1.

8. A pumpkin food, which is prepared by heat-cooking of the pumpkin for cooking of claim 7.
